(19) United States
(12) Patent Application Publication
(10) Pub. No.: US 2008/0079258 A1
(43) Pub. Date: Apr. 3, 2008

(54) Irrigation sprinkler adapter

(75) Inventors: Kenneth D. Siegel, Redondo Beach, CA (US); Joseph Nazari, La Crescenta, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Rain Bird Coporation, Azusa, CA (US)

(21) Appl. No.: 11/532,288

(22) Filed: Sep. 15, 2006

(51) Int. Cl. F16L 55/00

(52) U.S. Cl. 285/5; 285/18; 239/600

(57) ABSTRACT

An adapter to couple irrigation system components having differently sized and shaped connection points is provided. The adapter defines a throughbore, a first connection device on one end, and a second connection device on the other end. The first and second connection devices preferably have different sizes or shapes.

### FIELD OF THE INVENTION

The invention relates to a component of an irrigation system and, more particularly, to an adapter for coupling two portions of an irrigation system together.

### BACKGROUND OF THE INVENTION

Irrigation systems include a variety of differently sized components. For instance, an irrigation system often requires the interconnection of emission devices, nozzle assemblies, conduit, tubing, valves, manifolds, valve boxes, risers, and many other components in fluid communication with each other. Many of these components have differently shaped and sized interconnections and, therefore, can not be easily coupled in fluid communication.

For example, a nozzle assembly may have a FPT (female pipe thread) inlet of one diameter, but the riser to which it must be coupled has a MPT (male pipe thread) outlet of a different diameter. As a result, large inventories of irrigation components, each having differently sized and shaped interconnections, are required in order to assemble an irrigation system. These large inventories are costly and complicate the assembly of the sprinkler system due to the increased number of parts that must be accounted for and included with a system.

In another example, commercial irrigation systems often use polyflex risers to couple emission devices, such as drip emitters or bubblers, to the main distribution lines buried underground. The polyflex riser is thick-walled, high density polyethylene tubing that is an alternative to ¼ inch distribution tubing, which many commercial contractors consider substandard for use in coupling to an emission device above ground. The ¼ inch distribution tubing is less durable and subject to vandalism.

The polyflex riser is typically provided in set lengths which are cut to the desired size for the particular application in order to position the emission device at ground level or a desired height above ground level. Once cut, the polyflex riser typically has a smooth or unthreaded receiving end. As such, the polyflex riser is commonly free of any features or contours that may secure the riser to the desired emission device. Therefore, to assemble the emission device to the polyflex riser, one method typically involves a male coupling end on the emission device sized to be received in the inner diameter of the polyflex riser. The male coupling end may also be designed to self-tap the inner diameter of the polyflex riser in order to join the device to the riser more securely.

However, such coupling methods have the shortcoming that the coupling joint is often a weaker portion of the assembly and easily damaged by vandalism or broken by being stepped on accidentally. The male coupling is often structurally weaker because in order to be received in the inner diameter of the polyflex riser, the male coupling is typically smaller than the remaining body portion of the emission device. This smaller size of the coupling portion is weaker than the emission device body, especially at the transition between the male coupling and the body of the emission device.

Accordingly, there is a need for a simplified system to interconnect irrigation system components in fluid communication, preferably an emission device to a polyflex riser, in order to provide enhanced strength to the coupled assembly.

### BRIEF DESCRIPTION OF THE DRAWINGS

FIG. 1 is a perspective view of an adapter for use in an irrigation system;

FIG. 2 is a cross-sectional view of the adapter of FIG. 1;

FIG. 3 is a perspective view of the adapter of FIG. 1 shown coupled to a nozzle assembly and a riser;

FIG. 4 is a perspective view of a second alternative adapter for use in an irrigation system;

FIG. 5 is a cross-sectional view of the adapter of FIG. 4;

FIG. 6 is a perspective view of the adapter of FIG. 4 coupled to a riser and a nozzle assembly.

FIG. 7 is a cross-sectional view of a third alternative adapter for use in an irrigation system;

FIG. 8 is a cross-sectional view of a fourth alternative adapter for use in an irrigation system;

FIG. 9 is a cross-sectional view of a fifth alternative adapter for use in an irrigation system shown with a riser tubing coupled thereto; and

FIG. 10 is a cross-sectional view of a sixth alternative adapter for use in an irrigation system; and

FIG. 11 is a cross-sectional view of the adapter of FIG. 10 shown with a riser tubing coupled thereto.

### DESCRIPTION OF THE PREFERRED EMBODIMENTS

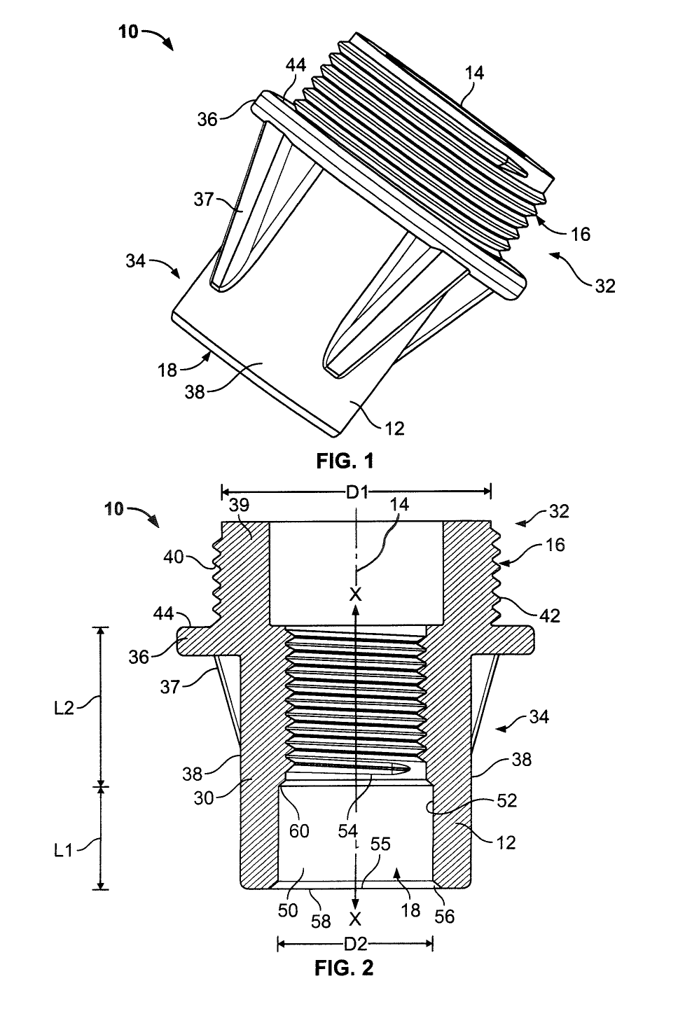

Referring to FIGS. 1 to 3, there is illustrated an adapter 10 configured to couple two portions of an irrigation system together. The adapter 10 defines a bore 14 extending therethrough. The adapter 10 includes a first connection device 16 on one end and a second connection device 18 on an opposite end to join two portions of the irrigation system together. In one form, the first connection device 16 permits the adapter 10 to receive a portion of an irrigation sprinkler system of a first size, and the second connection device 18 permits the adapter 10 to receive another portion of an irrigation sprinkler system of a second, different size.

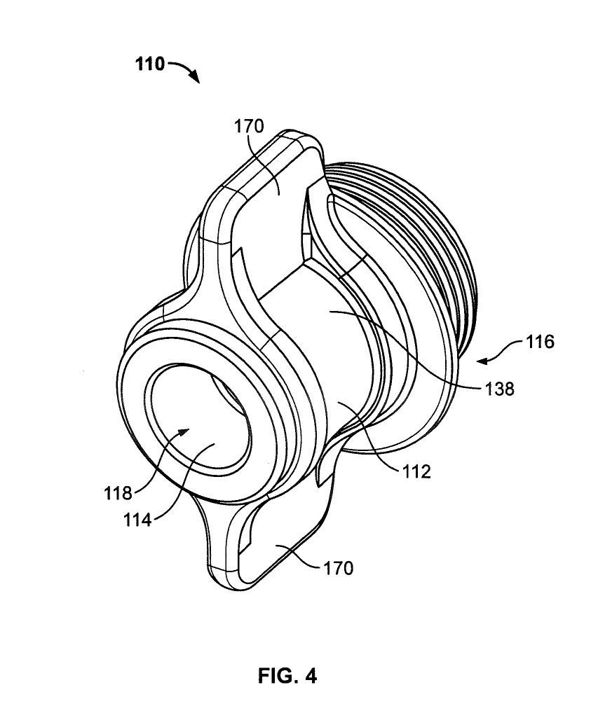

For example, as illustrated in FIG. 3, the adapter 10 permits a sprinkler nozzle assembly 20, which has a predetermined FPT inlet diameter, to be coupled to a tubular riser or other conduit 22, such as a polyflex riser, which has a different diameter. In such form, the adapter 10 advantageously provides a more robust and stronger connection to the riser 22 because the FPT inlet of the nozzle receives the adapter 10 therein rather than a narrow male inlet on a nozzle being received inside the riser 22.

The adapter 10 is also advantageous because it permits greater flexibility in designing, installing, and maintaining parts inventory for irrigation systems. The necessity of maintaining a large inventory of more expensive nozzle assemblies, each with different FPT input diameters, in order to couple to the variety of irrigation system parts is addressed. An inventory of less expensive adapters 10 may be maintained to join the nozzle assembly 20 to any size conduit 22 by simply selecting the appropriate adapter 10 with the desired size and shape of the connection devices 16 and 18 to fit the particular situation. While the adapter 10 preferably joins the nozzle assembly 20 to the riser 22, as shown in FIG. 3, the adapter 10 may also be used to couple other irrigation system components together in a similar fashion.

As described more fully below, the adapter 10 is preferably formed or molded from a material having a sufficient hardness, rigidity, and strength such that the second connection device 18 is suitable to self-tap or cut threads into the outer surface of the riser 22 or other tubular irrigation system component to be joined. As mentioned above, the riser 22 is often a typical plastic or polyflex riser; therefore, the adapter 10 is formed from a suitable material that permits the adapter 10 to self-tap such a riser. Preferably, the adapter 10 is injection molded from ABS, acetal, and like polymers. Use of these materials is preferred because they permit the adapter design to be robust. That is, not only does such materials have sufficient rigidity to permit the adapter 10 to be self-tapping, but such materials also permit the adapter 10 to have sufficient strength to generally be able to withstand vandalism and degradation due to UV light.

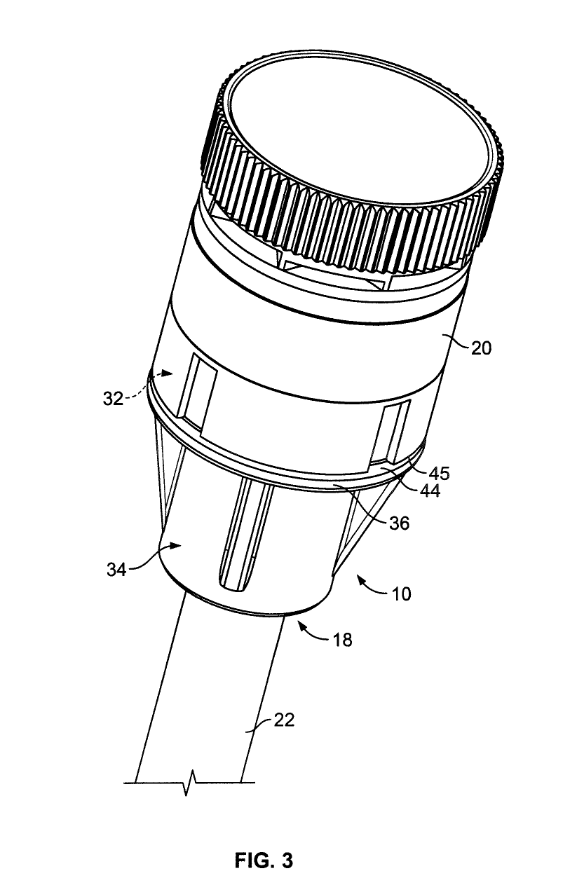

Referring more specifically to FIGS. 1 and 2, the adapter 10 preferably has a generally cylindrical shape that is formed from an annular wall 30 defining the bore 14. The bore 14 preferably is centrally disposed within the adapter body 12 about a central longitudinal axis X. The body 12 is divided into an upper portion 32, which defines the first connection device 16, and a lower portion 34, which defines the second connection device 18. An outwardly extending annular flange 36 separates the upper portion 32 from the lower portion 34.

To provide support and strength to the body 12, the adapter 10 preferably include ribs 37 that extend along an outer surface 38 of the body 12. As best illustrated in FIGS. 1 and 2, the ribs 37 project outwardly from the outer surface 38 of the adapter 10 and extend downwardly from the annular flange 36 along the lower portion 34. The preferred ribs 37 are generally triangular in shape and taper inwardly from the flange 36 to the outer surface 38 at a location spaced from the annular flange 36 to provide a more compact configuration. Other sizes and shapes of the ribs 37 are also suitable.

In addition to providing support, the ribs 37 also may provide a gripping structure that aids the user to hold onto or rotate the adapter during installation. Further, the ribs 37 also may minimize the amount of force needed to install the adapter 10. For example, the ribs 37 provide an extended surface or extension that permits greater leverage or torque upon holding and/or rotating the adapter 10 during installation. In this regard, the ribs also may include a tactile surface (not shown) to aid in gripping.

The preferred first connection device 16 is a threaded MPT or male connector 39 having an outer diameter D1 and configured to be threadably received in a corresponding FPT or female connector of an irrigation system, such as the female connecting end of the nozzle assembly 20 (i.e., FIG. 3). In this regard, the male connector 39 includes threading 40 on an outer surface 42. The diameter D1 may be about 0.58 to about 0.62 inches. It will be appreciated, however, that the type and size of the first connection device 16 may vary depending on the configuration and size of the nozzle assembly 20 or other portion of the irrigation system in which the connection device 16 is being joined thereto. For example, the connection device 16 may also be a FPT female connector, a friction connection, a universal joint, a snap connection, a quick-disconnect connection, or other connection mechanisms having a variety of diameters, sizes, and shapes.

The flange 36 also forms a stop for the first connection device 16. For instance, the adapter 10 will be fully inserted into the nozzle assembly 20 when an upper surface 44 of the flange 36 engages with a lower edge 45 of the nozzle assembly 20, as illustrated in FIG. 3. This engagement indicates that a sufficient connection to the nozzle assembly 20 or other irrigation system component has been achieved.

The lower portion 34 of the adapter 10 defines the second connection device 18. Preferably, the second connection device 18 is a female connector 50 having an inner diameter D2 configured to receive the riser 22 or other portion of an irrigation system. The diameter D2 of the second connection device 18 is different than the diameter D1 of the first connection device 16 so that the adapter 10 may couple two portions of irrigation systems with different sizes or diameters. The preferred diameter D2 is less than the diameter D1, and, for example, the diameter D2 may be an inner diameter of about 0.28 to about 0.32 inches.

As mentioned above, the female connector 50 is advantageous because it couples to the outer diameter of the riser 22—rather than the inner diameter as with current emission devices. Therefore, the adapter 10 and female connector 50 thereon provide a more robust and stronger connection to the riser 22 because of the increased size of the second connection device 18 that permits receipt on the outside of the riser 22 (i.e., in a female connection) rather the inside of the riser 22 as with the male connectors found on current emission devices. That is, as illustrated in FIG. 2, the female connector 50 is defined by the annular wall 30 of the adapter 10 and benefits from the strength provided by the annular wall 30.

The female connector 50 also is defined by the bore 14 and includes both a tube guide or smooth wall portion 52 and a FPT or female threaded portion 54. The tube guide 52 has a clearance fit with the riser so that a first distance L1 of the connector 50 functions to guide the upper end of the riser 22 to the threaded portion 54. Upon further insertion into the connector 50, such as a portion of the distance L2, the riser 22 engages the threaded portion 54 in order to form a secure connector with the adapter 10.

More specifically, as the riser 22 is preferably the polyflex riser that is commonly unthreaded at its insertion end, in order to form a secure connection with the adapter 10, the riser 22 is preferably inserted a portion of the distance L2 so as to be threadably engaged by the adapter 10. In this regard, the female connector 50 is preferably constructed to self-tap the outer surface of the riser 22 in order to form a threaded connection thereto. For example, by rotation of the riser 22 into the second connection device 18, the female connector 50 will tap or cut threads into the outer surface of the riser 22 via the threads of the threaded portion 54. The threads 54, therefore, have a sufficient strength to tap the material of the riser 22.

The adapter 10 also avoids the use of a separate tapping or threading tool because the adapter 10 self-taps the generic or smooth end of the riser 22 itself. This arrangement requires that the inner diameter of the smoothed portion 52 and the outer diameter of the riser 22 be close in dimension, such as about 0.300 to about 0.304 inches for the adapter inner diameter D2 and about 0.298 to about 0.302 inches for the outer diameter of the riser 22. On the other hand, if the riser 22 also includes a threaded insertion end, the riser 22 may be fully inserted in the female connector 50 such that the FPT or female threaded portion 54 of the second connection device 18 may threadably mate with any corresponding MPT end of the riser 22.

The type and size of the second connection device 18 also may vary depending on the configuration and size of the riser 22 or other portion of the irrigation system to which the connection device 18 is being joined. For example, rather than the threaded portion 54, the adapter may include a friction-fit or press-fit connecting portion. In addition, the connection device 18 also may include a MPT male connector, a friction connection, a universal joint, a snap connection, a quick-disconnect connection or other connection mechanisms accommodating a variety of diameters, sizes, and shapes.

Referring to FIG. 2, to guide insertion of the riser 22 into the female connector 50, a terminal edge 55 of the bore 14 preferably includes a chamfered profile 56. The angled surface of the chamfered profile guides the end of the riser 22 into the bore 14. In one form, the angled surface is at an angle of about 44° to about 46° relative to the terminal end face. However, other angles and configurations may also be appropriate to guide and otherwise enhance insertion into the second connection device 18. For example, the profile 54 also may be a bevel, a stepped profile, a curved profile, or the like.

To help facilitate the self-tapping of the threads 54 into a riser 22, there also may be a transition 60 between the smooth bore portion 52 and the threaded bore portion 54. The transition 60 is angled inwardly between about 44° to about 46° at the transition between the threaded and smooth portions 54 and 52, respectively. The transition 60 aids in the threads 54 biting into an outer surface of the riser 22. The transition 60 also may include other forms, shapes, angles, and sizes to enhance the self-tapping function of the threads 54.

Referring to FIGS. 4 to 6, there is illustrated an alternative adapter 110 for coupling irrigation system components together. The adapter 110 also joins irrigation system components of different sizes (i.e., nozzle assemblies, risers, conduit, pipe, tubing, etc.) in fluid communication with each other in a fashion similar to the adapter 10 previously described. As such, the adapter 110 includes many of the same features described above for adapter 10, and thus, only the differences over the adapter 10 are described below.

The adapter 110 defines a bore 114 extending centrally therethrough. The preferred adapter 110 has a generally cylindrical shape with an annular wall 130. A first connection device 116 is on one end of the adapter 110, and a second connection device 118 is on another end of the adapter 110. The first connection device 116 is preferably a male connector 139, and the second connection device 118 is preferably a female connector 150.

The adapter 110 includes wings 170 extending outwardly from an outer surface 138. The wings 170 facilitate the joining of an irrigation system component (i.e., nozzle assembly or riser) to either the first connection device 116 or the second connection device 118. More specifically, the extension of the wings 170 provides increased leverage or torque for threading, self-tapping, and/or frictionally receiving the irrigation system components, such as a riser pipe, into the connection devices 116 and 118.

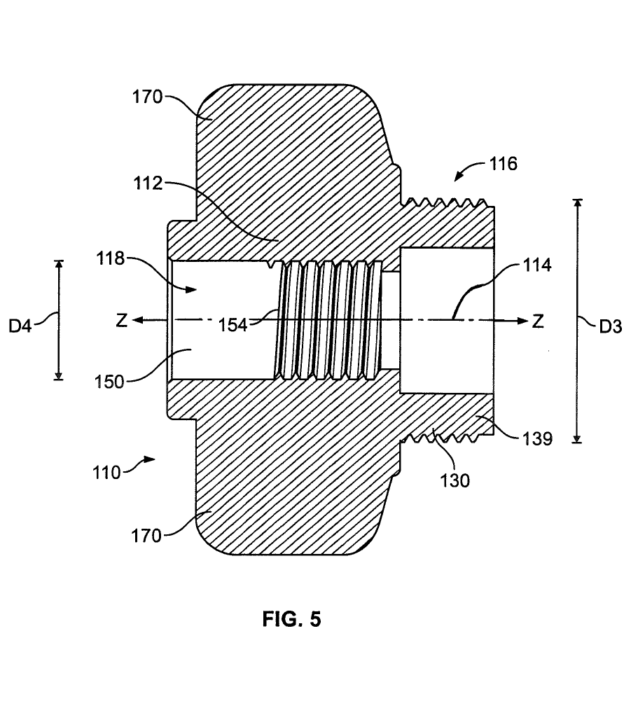

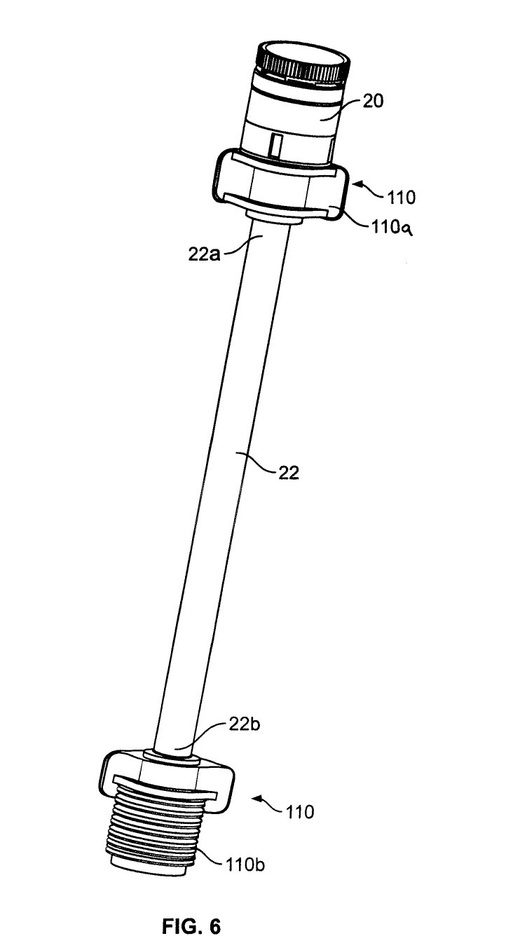

As shown in FIGS. 4 and 5, the pair of wings 170 of the preferred adapter 110 are spaced circumferentially about 180° apart. In addition, each preferred wing 170 may extend about 0.6 inches outward from a center axis Z of the adapter 110 (FIG. 5). This length provides an adequate increase in leverage or torque. The adapter wings 170 also provide a consistent visual appearance with an adapter or other component used on the opposite side of the riser 22 (i.e., see FIG. 6). It should be appreciated that the length and size of the wings may vary depending on the amount of additional leverage desired and/or required taking into consideration other design constraints, such as overall size.

The first connection device 116 has a diameter D3, which is preferably an outer diameter of about 0.58 to about 0.62 inches, and the second connection device 118 has a diameter D4, which is preferably an inner diameter of about 0.28 to about 0.32 inches. The adapter 110 joins irrigation system components of different sizes to be in fluid communication.

Referring to FIG. 6, the adapter 110 is illustrated in two different exemplary uses in an irrigation system. The adapter 110 is joined to both ends 22a and 22b of the riser 22. A first adapter 110a couples the riser end 22a to the nozzle assembly 20 in a similar fashion as described above with adapter 10, and a second adapter 110b couples the other riser end 22b to another irrigation system component (not shown) also in a fashion as previously described. In such configuration, the riser 22 having one size may be coupled to the nozzle assembly 20 of another size, as well as another irrigation system component of yet a third size.

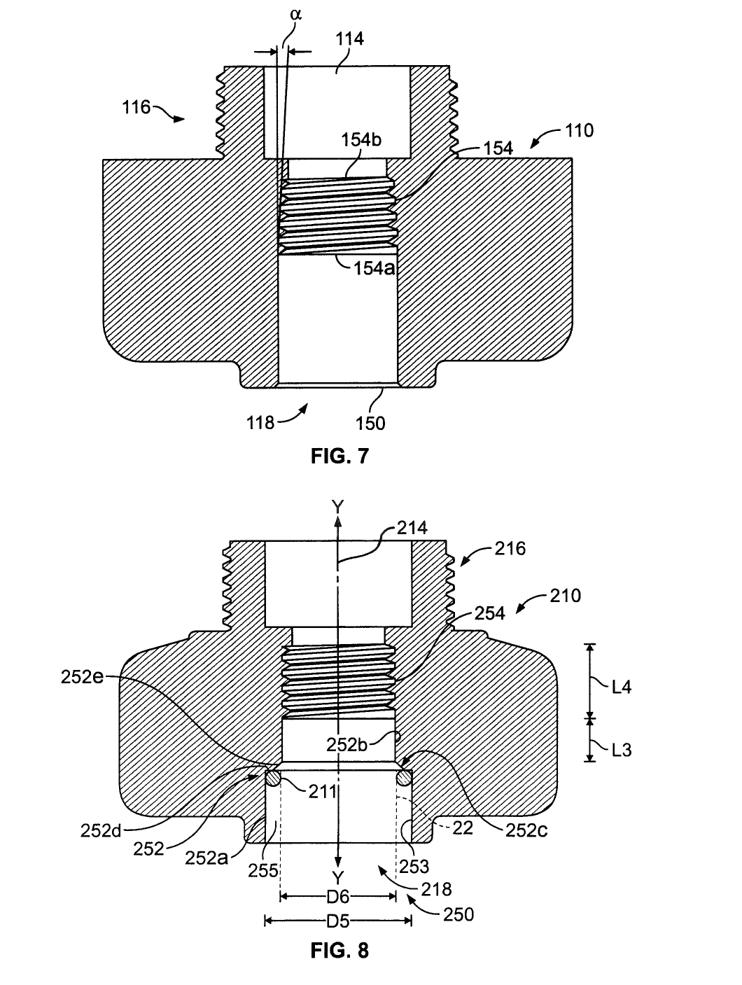

Referring to FIG. 7, an alternative configuration of the threaded portion 154 in the adapter bore 114 is illustrated. In this alternative form, the threaded portion 154 includes a taper α, where the walls of the bore angle inwardly toward the bore axis Z from one end of the threaded portion 154 to the other. In one form, the taper α of the threaded portion 154 is formed by gradual and constant decrease of the thread diameter from a first end 154a to a second end 154b of the bore 114. For example, the threaded portion 154 may include a taper α of about 2 to about 3°. Such taper enhances the fluid sealing between the coupled riser 22 and the adapter 110.

The taper α also permits ease of insertion of the riser 22 into the female connector threaded portion 154, and also helps facilitate the self-tapping of the riser 22 with a minimal amount of initial leverage. For instance, initial insertion of the riser 22 at the threaded portion first end 154a is relatively easy due to the larger diameter thereof. As the riser 22 is inserted further into the bore 114, the amount of force needed to thread the riser 22 progressively increases due to the taper α. In this manner, the further the riser 22 is inserted into the threaded portion 154, the more secure the connection to the adapter 10. Additionally, to vary the holding power of the threaded portion 154, more or less threads could be included to increase or decrease, respectively, the ability of the adapter to hold the riser 22.

Referring to FIG. 8, there is illustrated another alternative adapter 210. In this embodiment, the adapter 210 includes a seal 211, such as an O-ring-type seal, to seal between the adapter and the riser.

As with the previous embodiments, the adapter 210 defines a bore 214 extending therethrough with a first connection 216 on one end and a second connection device 218 on the other end. Preferably, the first connection device 216 is the previously described male connector 39, such that the first connection device 216 may be threadably received in a corresponding FPT connector of an irrigation nozzle.

The second connection device 218 is a female connector 250 defining a threaded portion 254 and a stepped portion 252, which permits the receipt of the riser 22 along with the seal 211 therein. Preferably, the stepped profile 252 of the female connector 250 has a larger segment 252a with a first diameter D5, and a smaller segment 252b with a second, smaller diameter D6 and a transition portion 252c connecting the larger and smaller segments. As further described below, the larger segment 252a forms a pocket for receipt of both the riser 22 and the seal member 211.

The preferred transition portion 252c includes both a flat portion 252d and a tapered portion 252e. The flat portion 252d extends radially inward to the bore 214 from inner walls 253 of the larger segment 252a and is preferably transverse to an axis Y through the bore 214 so as to provide a seating surface for the seal 211. The tapered portion 252e angles inwardly into the bore towards the axis Y from a distal end of the flat portion 252d. The preferred tapered portion 252e may extend into the bore at an angle of about 44° to about 46° degrees with respect to the axis Y, which aids to guide the riser 22 into the smaller segment 252b.

As with the other embodiments, the riser 22 may be received in the adapter 210 in a variety of different configurations. For instance, if only a friction fit or press-fit is desired with the adapter 210, the riser 22 may be inserted a first distance, such as any portion of the distance L3, into the smaller segment 252b. This arrangement, therefore, requires that the diameter D6 of the smaller segment 252b and the outer diameter of the riser 22 to preferably be nearly the same, such as about 0.300 to about 0.304 inches for the adapter inner diameter D6 and about 0.298 to about 0.302 inches for the outer diameter of the riser 22.

However, for a more secure connection, the riser 22 also may be inserted further in the female connector 250 to form a threaded connection therebetween. In this regard, the bore 214 also includes the threaded portion 254. Therefore, if the riser 22 is inserted a second, further distance (i.e., any portion of distance L4) into the bore 214, the adapter may threadably receive the riser 22 either by self-tapping the riser 22 or by coupling with corresponding threads on the riser 22 similar to the previous embodiments. The threads in the threaded portion 254 may also be tapered to ease insertion of the riser 22 during self-tapping and enhance fluid sealing between the adapter 210 and riser 22, as previously discussed with the adapter 110 of FIG. 7.

Referring to FIG. 8, whether the riser 22 is inserted to portions of the distance L3 or L4 as described above, an annular space 255 is formed between the outer wall of the riser 22 and the inner wall 253 of the larger segment 252a. The space 255 results from the diameter D5 of the segment 252a being larger than the outside diameter of the riser 22 (e.g., about 0.298 to about 0.302 inches). For example, the diameter D5 may be about 0.39 inches such that the space 255 has a radial width of about 0.044 to about 0.046 inches. Within the space 255, the seal 211 is wedged or compressed on the annular corner between the wall 253 and the flat portion 252d, and the outside surface of the riser 22 in a tight friction fit. The seal 211, therefore, preferably has a cross-sectional diameter that is slightly larger than the radial width of the space 255. In one form, the seal 211 has a cross-sectional dimension such that it is compressed by about 0.010 inch within the space 255. This wedging of the seal 211 within the stepped portion 252 of the female connector 250 enhances the fluid sealing between the adapter 210 and a riser.

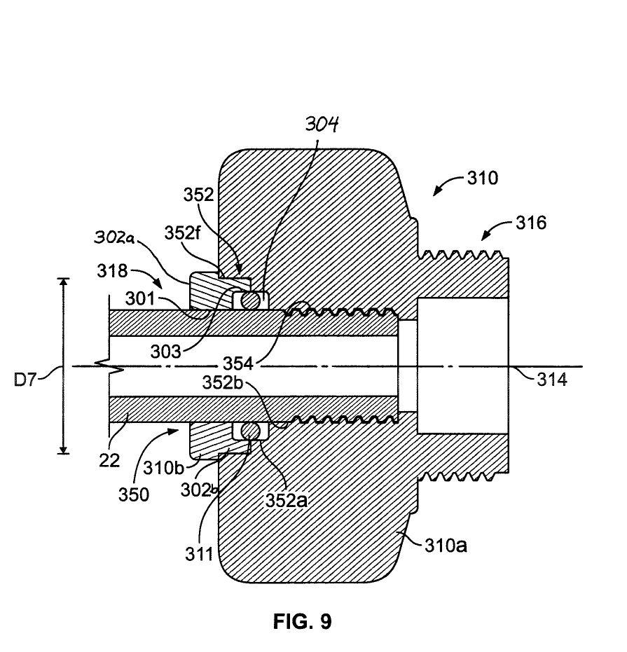

Referring to FIG. 9, another alternative adapter 310 is illustrated showing additional fluid sealing features. In this embodiment, the adapter 310 includes a two-piece body having a main body 310a and a cap 310b that captures a seal 311, such as an O-ring, between the riser 22 and the main body 310a. The body 310a and the cap 310b cooperate to define an annular groove for the seal 311. The two-piece body of the adapter 310, therefore, provides another mechanism to enhance the fluid sealing characteristics between the adapter 310 and the riser 22.

Similar to the previous embodiments, the adapter 310 defines a bore 314 extending therethrough with a first connection 316 on one end and a second connection device 318 on the other end. Preferably, the first connection device 316 is the previously described male connector 39, such that the first connection device 316 may be threadably received in a corresponding FPT connector of an irrigation nozzle. The second connection device 318 is preferably a female connector 350 defining both a multi-contoured inner profile 352 and a threaded portion 354 so that the female connector 350 may frictionally receive and/or threadably receive (i.e., self-tap or threadably mate) with the riser 22 similar to the other embodiments described herein.

More specifically, the multi-contoured profile 352 of the female connector 350 preferably has a shape that permits the receipt of the riser 22, the seal 311, and a portion of the cap 310b within the female connector 350. For instance, the profile 352 includes a first, larger diametered portion 352a sized for receipt of a portion of the seal 311 between an outside surface of a riser 22 and an inner wall 353 of the larger diametered portion 352a. The profile 352 also includes a second, smaller diametered portion 352b, which is spaced axially inward along the bore 314, to preferably receive the riser 22 in a tighter, friction-type fit. The adapter 310 may also include a stepped transition portion (not shown in this view), such as the transition portion 252c of the adapter 210 of FIG. 8. In order to receive the cap 310b, the multi-contoured profile 252 also includes an annular cap-receiving portion 352f at the outer end of the bore 314 that preferably has a diameter, which is larger than both the diameters of the first portion 352a and the second portion 352b.

The cap 310b is preferably in the form of a disk that defines a central opening 301 for the riser 22 to extend therethrough. The cap 310b includes a base portion 302a and a neck portion 302b, which is sized to be received in the annular cap-receiving portion 353f preferably via a snap fit, a press-fit, or a welded arrangement. In this regard, the cap neck portion 302b preferably has a diameter that is close to the diameter of the annular cap-receiving portion 353f of the body 310a. While it is preferred that the neck portion 302b be either press-fit or welded into the adapter main body 310b, it will be appreciated, however, that any fluid-tight sealing method may be employed to secure the cap 310b to the adapter body 310a.

Within the neck portion 302b, the cap 310b defines an inner annular groove 303 that is sized to receive a portion of the seal member 311 therewithin when assembled to the adapter main body 310a. That is, the cap 310b includes an annular recess that opens radially inward from the neck portion 302b to the central opening 301. When the cap 310b is assembled with the main body portion 310a, the cap annular groove 303 and the main body larger diametered portion 352a cooperate to form an annular chamber 304 that defines the space for the seal 311. The chamber 304 preferably has a size such that the seal 311 is wedged within the space in a tight, friction fit in order to provide fluid sealing characteristics to the adapter 310. The cap 310b is advantageous because it more securely holds the seal 311 within the female connector 350.

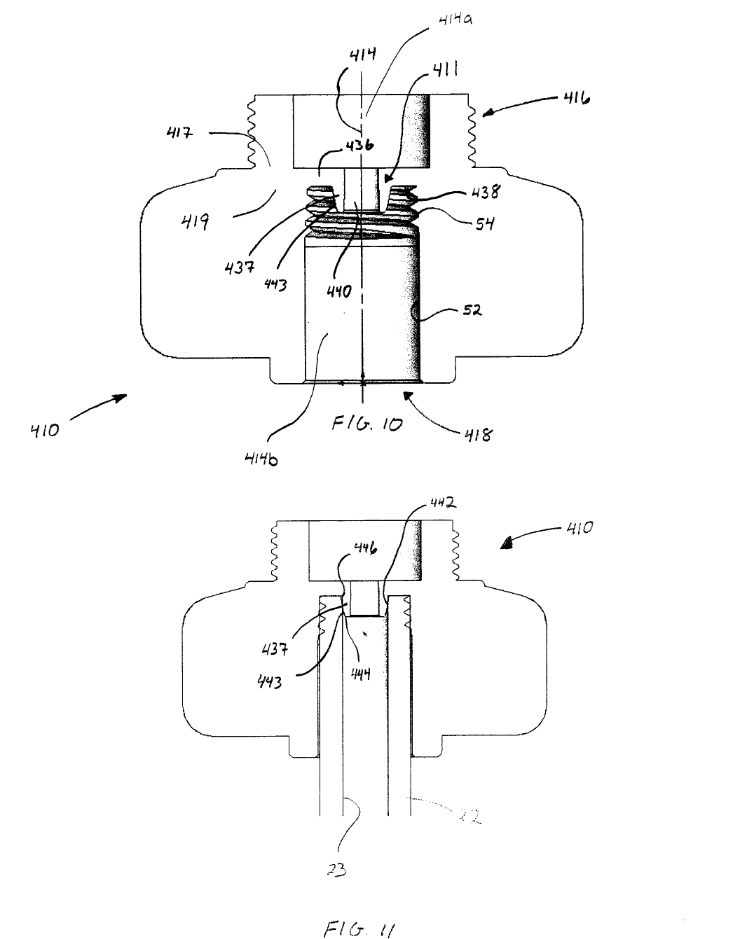

Referring now to FIGS. 10-11, another alternative adapter 410 is illustrated. In this embodiment, the adapter 410 includes an integral seal structure 411 that enhances the fluid sealing characteristics between the adapter 410 and an inner wall 23 of the riser 22 received within the adapter 410.

Similar to the previous embodiments, the adapter 410 defines a bore 414 extending therethrough with a first connection 416 on one end and a second connection device 418 on the other end. Preferably, the first connection device 416 is the previously described male connector 39, such that the first connection device 416 may be threadably received in a corresponding FPT connector of an irrigation nozzle. The second connection device 418 is preferably the previously described female connector 50 defining both the smooth wall portion 52 and the threaded portion 54 so that the second connection device 418 may threadably receive (i.e., self-tap or threadably mate) with the riser 22 similar to the other embodiments described herein. As shown in FIG. 10, the threaded portion 54 of the second connection device 418 in this embodiment is modified to include a reduced number of threads as compared to the embodiment illustrated in FIG. 2, and therefore, provides for a quicker installation of the riser 22 because less threading is required to fully receive the riser 22 within the second connection device 418. It will be appreciated that more or less threads may be included in the second connection device 418 as needed to increase or decrease the ability of the adapter 410 to hold the riser 22.

In this embodiment, the bore 414 is divided into two portions 414a and 414b by a wall or septum 436 that extends inwardly to the bore 414 from an inner wall of the bore approximately between a lower portion 417 of the male connector 39 and an upper portion 419 of the female connector 50. Disposed on the septum 436 is the internal seal structure 411. Preferably, the seal structure 411 includes an annular wall 437 that depends downwardly from a lower surface 438 of the septum 436. The annular wall 437 defines a passage 440 through the septum 436 that provides fluid communication between the two bore portions 414a and 414b.

In order to form a substantially fluid tight seal with a riser 22, the annular wall 437 defines a sealing portion 442 along a length thereof that seats against the inner wall 23 of an inserted riser 22 via an interference fit as shown in FIG. 11. More specifically, the annular wall 437 preferably has an outer surface 443 that tapers radially outward from a lower edge 444 to an upper edge 446. In one form, the taper of the annular wall is about 10 to about 20 degrees.

When the riser 22 is inserted into the second connection device 418, the sealing portion 442 contacts the inner wall 23 of the riser 22, preferably in an interference fit, to form the substantially fluid-tight seal. In this manner, fluid preferably flows through the bore portion 414b and passage 440 into the bore portion 414a with minimal or no fluid leakage between the annular wall outer surface 443 and the riser inner wall 23.

It will be understood that various changes in the details, materials, and arrangements of parts and components which have been herein described and illustrated in order to explain the nature of the invention may be made by those skilled in the art within the principle and scope of the invention as expressed in the appended claims. Furthermore, various features have been preferably described regarding the adapters 10, 110, 210, 310, and 410; however, it will be appreciated that the details of the various embodiments are not limited to the specific embodiment in which they were described. It is within the scope herein to include any feature described with one embodiment with any other embodiment described herein. Finally, various dimensions are provided with some of the embodiments. Any dimensions included herein are only exemplary and may be varied as needed to fit a particular system.

What is claimed is:

1. An irrigation system coupler comprising:
a body defining a passage and having external threading and an outer diameter of a first dimension;
a first portion of the passage having an inner diameter of a second dimension and the second dimension different than the first dimension; and
a second portion of the passage cooperating with the first portion of the passage and having self tapping internal threading.

2. The irrigation system coupler of claim 1 wherein the first dimension is greater than the second dimension.

3. The irrigation system coupler of claim 1 wherein the first portion of the passage is defined by a generally smooth surface of the body.

4. The irrigation system coupler of claim 1 wherein the self tapping internal threading is made from ABS.

5. The irrigation system coupler of claim 1 further comprising at least one extension from the body to assist the installation of the coupler.

6. The irrigation system coupler of claim 5 wherein the at least one extension includes at least two extensions extending from opposite sides of the body.

7. The irrigation system coupler of claim 1 further comprising a stop extending from the body in association with the external threading.

8. The irrigation system coupler of claim 1 further comprising a third portion of the passage having an inner diameter of a third dimension and the third dimension being different than the second dimension and a seal received in the third portion.

9. The irrigation system coupler of claim 8 further comprising a cap at the passage to capture the seal within the third portion of the passage.

10. The irrigation system coupler of claim 9 wherein the cap defines an opening and an annular groove surrounding the opening, the seal being received at least in part in the annular groove.

11. The irrigation system coupler of claim 1 wherein the body further comprises a septum dividing the passage into two portions; an annular wall depending from the septum and defining an opening through the septum; and wherein an outer surface portion of the annular wall provides fluid sealing between the coupler and an irrigation system component inserted into the passage.

12. An irrigation sprinkler assembly comprising:
a sprinkler housing defining an inlet having a first diameter;
a conduit having an outlet portion of a second diameter, the second diameter being different than the first diameter; and
an adapter with a first connector configured to receive the outlet portion of the conduit and a second connector configured to insert into the sprinkler housing at the inlet.

13. The irrigation sprinkler assembly of claim 12, wherein the inlet of the sprinkler housing has first internal threading and the first connector includes external threading for threadably coupling with the internal threading of the inlet.

14. The irrigation sprinkler assembly of claim 13, wherein the adapter includes an inner surface defining a passage and the second connector includes second internal threading at the inner surface to threadably couple to the outlet portion of the conduit.

15. The irrigation sprinkler assembly of claim 14, wherein the adapter comprises material of sufficient integrity to self-tap threading on to the outlet portion of the conduit.

16. The irrigation sprinkler assembly of claim 15, wherein the material is ABS.

17. The irrigation sprinkler assembly of claim 14, wherein the second connector includes a smooth surface portion at the inner surface defining the passage.

18. The irrigation sprinkler assembly of claim 14, further comprising a seal received in the passage disposed between the passage inner surface and an outer wall of the conduit.

19. The irrigation sprinkler assembly of claim 18, further comprising a cap received in the passage to capture the seal within the passage.

20. The irrigation sprinkler assembly of claim 19 wherein the cap defines an opening through which the conduit passes through and an annular groove surrounding the opening, the seal being received at least in part in the annular groove.

21. The irrigation sprinkler assembly of claim 14, wherein the adapter further comprises a septum dividing the passage into a first portion and a second portion; an annular wall depending from the septum and defining an opening through the septum; and an outer surface portion of the annular wall contacting an inner wall surface of the conduit to provide a fluid sealing therebetween.
